(19) United States
(12) Patent Application Publication
(10) Pub. No.: US 2003/0192118 A1
(43) Pub. Date: Oct. 16, 2003

(54) MARPET SLING (PATIENT LIFTING SLING)

(76) Inventors: Margaret A. Carbonneau, Barrhead (CA); Petrona M. Skoye, Wabamun (CA)

Correspondence Address: Margaret Carbonneau, 2156 Millwoods Road, Edmonton, AB, T6K2P4, CA

(21) Appl. No.: 10/122,652

(22) Filed: Apr. 15, 2002

(51) Int. Cl. A61G 1/00; A61G 7/10

(52) U.S. Cl. 5/89.1

(57) ABSTRACT

The present invention relates to a one piece sling for lifting and transferring a patient. In hooking ‘this’ sling to a lifting device, better support is provided to patients by being lifted at the shoulders and upper thighs in a sturdy sitting position. The maneuvering of the patient in this sitting position reduces the risk of strain on both the attendant and patient.

The present invention relates to a one piece sling for lifting and transferring a patient. In hooking ‘this’ sling to a lifting device, better support is provided to patients by being lifted at the shoulders and upper thighs in a sturdy sitting position. The maneuvering of the patient in this sitting position reduces the risk of strain on both the attendant and patient.

### PRIOR ART

Working conditions are often problematic when nursing disabled patients. Lifting the patient is ergonomically difficult for the personnel. They are at risk for back injuries. Today, there are many kinds of auxiliary equipment available for transferring and lifting patients. Various lifting devices, for example mobile lifting devices on legs, bathroom lifters, hoists in the ceiling, etc. Are commonly used. When the patient is dressed in a lifting vest, a one-piece garment or a sling, they are secured to a lifting device usually by means of straps. Thus, the patient is carried by the lifting sling and can be transferred to and from a wheelchair by means of the lifting device.

U.S. Pat. No. WO9415569 discloses a garment to be worn continuously, covering the body and upper legs. One drawback of prior art continuous wear garment is that the patient would have to wear it continuously during their waking hours. This would make it difficult to provide basic nursing care; personal hygiene care as well as treatments etc. Another drawback is patients with debilitating diseases such as arthritis and contractures would have difficulty putting on such a garment. Lastly, patients would have to have their own garment and this would not be cost effective for most facilities.

The lifting slings on the market at present e.g. (patent #CA 1288 379, U.K. 22234 77 A, U.K. 2184706 A, U.S. Pat. Nos. 292,048, 1,961,119, 2,688,410, 2,739,783, 2,792,052, 2,835,902, 3,222,029, 3,310,816, 3,699,594, 3,962,737, 3,998,284, 4,070,721, 4,232,412, 4,633,538, 4,712,257, 5,022,106, 5,396,670) usually have a four-point securing system for the supporting straps of the lifting device. Two of them in the shoulder region and two in the thigh region of the patient. Staff are very anxious and patients are very insecure and fearful when using these hammock style slings. The patients are too free to move side-to-side or fall foreword, putting them at risk for injury. These hammock styled sling cause the patients body to be raised in a slouched position making it difficult for positioning into a wheelchair or onto a commode, causing discomfort to the patient by being positioned inappropriately. Staff members have difficulty and can cause strain on their backs in the process of trying to reposition the patient. The toilet sling which lifts under the arms and legs give no support on the lower back. The gravity of the patients body weight pulls down on the sling that fits under the arms forcing the arms to raise unnaturally, possibly causing injury to the shoulder in the form of dislocation, fracture or are at risk of falling through.

### DISCLOSE OF INVENTION

The object of the present invention is to reduce the drawbacks discussed above and to provide a more comfortable means to lift and transfer a patient. This sling can be put on and removed easily. It will provide a better sense of security for both the patient and the staff member. This sling lifts the patient in a secure upright sitting position making it easier to place the patient in a wheelchair or on a commode, without causing discomfort to the patient or placing strain on the staff members. The four lifting points (6 AR, 6 AL, 2 AR, 2 AL) two on the top of the shoulders (6 AR, 6 AL) and two on the top of the thighs (2 AR, 2 AL), cause the patient to be lifted in a straight sitting position. The seat-belt strap (4) just provides another support and helps in preventing a falling foreword or moving from side-to-side motion. This gives the patient a cradling feeling and provides a sense of security. The sling should be made of durable fabric, for it will have to hold varying weights and be washed frequently.

### SPECIFICATIONS

1. This sling will be made of a one piece sturdy material in a one-piece size, adjustable by existing loops. The loops (6 BL, 6 BR) are an extension of 6 as well as the securing means (6 AL, 6 AR) which provides a stronger link and is attached to the back of the sling in a cross fashion as shown in FIG. 1. Also loops (2 BL, 2 BR) are an extension of 2 as well as securing means (2 AR, 2 AL). Like wise to provide a stronger link and is attached to the back of thigh extensions (1) as demonstrated in FIG. 1.

2. SL crossed over to 7 R and 6 AR is pulled through 6 BL: 5 R crosses over to 7 L and 6 AL is pulled through 6 BR 6 AR and 6 AL attaches to the lifting means. Crossing across the chest, prevents the arms from being pulled unnaturally upward at the same time providing support so the patient does not fall foreward. This security relieves some of the apprehension felt by patient and attendant. By lifting from the top of the shoulders the patient is being held in a more upright sitting position This allows direct placement without risk of injury to patient of attendent. Physical manipulation by attendant in order to place patient, may cause back strain to attendent or unnecessary discomfort to patient.

3. 4 is an adjustable waist belt. This additional safety belt keeps sling in place as well as providing the patient with extra security.

4. 2 AL is pulled through 2 BL; 2 AR is pulled through 2 BR. 2 AR and 2 AL is attached to the lifting means. This method of upper thigh lift aides in lifting upright sitting position. By lifting from the top of the thighs, it eliminates discomfort of injury to the groin area: especially in males.

### DESCRIPTION OF THE DRAWINGS

FIG. 1 A back view of lifting sling for a patient

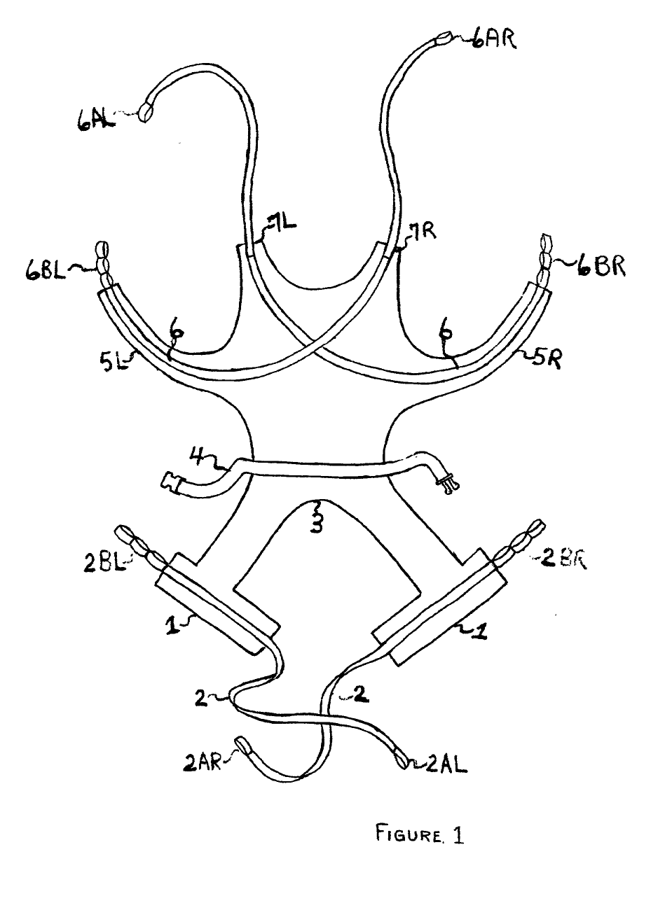

FIG. 2 A side frontal view of how sling would look on patient while being lifted.

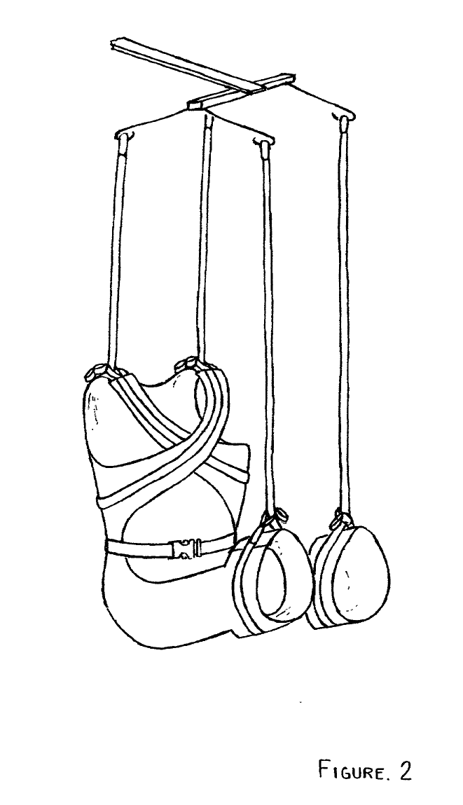

We claim:

1. A lifting means for lifting and transferring a patient by means of a sling having supporting means, with straps (6AR, 6AL, 2AL, 2AR) for connecting a lifting means to a lifting device, characterized by the sling which covers the patient's back and then comes around the arms crossing over the chest and looping through at the shoulders and surrounds the thighs by crossing over in the front of the thighs, having in the shoulder region, and the thigh region at a distance from the knees, securing means (6AL, 6AR, 2AL, 2AR ) for securing the sling to the supporting means of the lifting device, also an adjustable waist seat belt, (4) which is located mid-way from underarm and thigh region.

2. A sling according to claim 1, with an adjustable waist seat belt (4) which helps prevent movement forward or side-to-side, characterized in that during the operation the weight load caused by the lifting operation is imposed on the back portion and in the seat portion of the sling.

3. A sling according to claims 1 or 2, characterized in that a first set of strap-like or corresponding backings (6) are provided in the sling to extend from the shoulder line to the opposite underarm in a cross-like fashion like suspenders, and that a second set of strap-like or corresponding backings (2) are provided, extending from the outer edge of the thigh portion surround the thigh completely, and the third strap-like (4) with connecting buckles and adjustable lengths is attached to waist line of sling.

4. A sling according to claims 1, 2 or 3, characterized in that the first securing means are provided in the backings substantially in the region of the shoulder line (6BL,6BR) and that the second securing means are provided in the second backings in the front of the leg (2BL,2BR) at an appropriate distance upwards from the knee, and third securing means (4) is located midway from underarm and thigh region.

5. A sling according to claims 1, 2, 3 or 4, characterized in that the first two securing means (6AL,6AR,2AL,2AR) thread through adjustable strap loops (6BL,6BR,2BL,2BR) to be secured to the supporting means of the lifting device and the third securing (4) has an inter-locking buckle.
